(19) United States
(12) Patent Application Publication
(10) Pub. No.: US 2007/0126283 A1
(43) Pub. Date: Jun. 7, 2007

(54) CIRCUIT FOR ENABLING OR DISABLING A BRAKING SYSTEM OF A HYDRAULIC PROPEL DRIVE

(75) Inventor: Reinhardt Thoms, Neumunster (DE)

Correspondence Address: ZARLEY LAW FIRM P.L.C., CAPITAL SQUARE, 400 LOCUST, SUITE 200, DES MOINES, IA, 50309-2350, US

(73) Assignee: SAUER-DANFOSS INC., Ames, IA (US)

(21) Appl. No.: 11/562,028

(22) Filed: Nov. 21, 2006

(30) Foreign Application Priority Data
Dec. 7, 2005 (DE) 10 2005 058454.3

(51) Int. Cl. B60T 13/00

(52) U.S. Cl. 303/89; 303/20; 303/191

(57) ABSTRACT

The invention relates to a circuit for enabling or disabling a braking system of a hydraulic propel drive, having a device for checking operating parameters which are relevant to a neutral setting and having a spring device, in particular a load spring, which acts counter to the control piston of an electrohydraulic solenoid valve which is designed to enable the braking system by means of electrical operation. A device for generating a force, which is dependent on the neutral position, of the spring device is provided, wherein when a neutral setting is not present, the force action of the spring arrangement prevents the electrohydraulic solenoid valve from enabling the braking system, by acting counter to the electrical operation of the magnet of said solenoid valve.

### BACKGROUND OF THE INVENTION

The invention relates to a circuit for enabling or disabling a braking system of a hydraulic propel drive according to the features of Claim 1.

In hydraulically driven vehicles, it must be checked several times before releasing the brakes after stopping whether the hydraulic propel drive is actually in a neutral setting. If such checks are not carried out, sudden unpredictable acceleration or unexpected steering movements can occur.

There have been a very wide variety of proposals for carrying out checking in the above described context. For example, the checking can involve determining the positions of parts which are relevant to a neutral setting, such as swashplate, servo pistons, loop flushing valves and the like at which transducers are provided, whose signals are processed in order to enable the actuation of the relief valve for the brakes or to prevent said enablement if the transducers indicate impermissible deviations.

Another method is to monitor the pressures (high pressure, servo pressure, scavenging pressure) in suitable lines. As long as corresponding pressure sensors are already provided in the hydraulic system, the signals of said sensors can be utilized to enable or disable the actuation of the relief valve for the brakes.

Relevant designs are therefore based on the principle of detecting operating parameters which are relevant to a neutral setting, for example the position of a component which is relevant to the neutral setting or the pressure in a corresponding relevant line, to generate an electrical or hydraulic signal from said operating parameter, and to supply said signal to a suitable processor. The processing device gives the signal to release the brakes only when this is permitted by a corresponding result from the position monitoring or pressure monitoring.

The signal to release the brakes is primarily an electrical signal which switches a solenoid valve which produces the pressure level for engaging or releasing the brakes. Such a system comprises a complex chain of components and signal lines, for example in the form: position/pressure—5 transducer—signal—evaluation unit—operator switch—solenoid valve—pressure—brake.

Such a system therefore comprises several hydraulic and electrical lines. Out of principle, said system is arranged decentrally, that is to say the transducer is situated on the hydraulic pump or on the hydraulic motor, while connections lead from there to a remote evaluating unit, a computer or a relay. The evaluating unit is connected at the other side to an operator switch which is situated at another location, with further connections leading in turn from said operator switch to the solenoid valve which is situated, for example, at the brakes. The solenoid valve itself must be supplied with pressure and for this purpose requires a corresponding hydraulic connection to a pressure oil source and to a relief line (tank). The solenoid valve must additionally be connected to the brakes so that the brakes can also be pressurized and depressurized, requiring a further hydraulic line. The design of such a system is therefore always associated with substantial assembly complexity and considerable costs.

### SUMMARY OF THE INVENTION

The present invention is intended to provide a simple and compact circuit for enabling or disabling the braking system of a hydraulic propel drive.

Said aim is achieved according to the invention by means of a circuit for enabling or disabling a braking system of a hydraulic propel drive, having a device for checking operating parameters which are relevant to a neutral setting and having a spring device which acts counter to the control piston of an electrohydraulic solenoid valve which is designed to enable the braking system by means of electrical operation. The signal of the device for checking operating parameters which are relevant to a neutral setting, that is to say, for example, the position signal of suitable components or the pressure signal in pressure lines which are relevant to a neutral position, is utilized to generate a force, which is dependent on the neutral position, of the spring device, for example a load spring. Said force acts against the control piston, wherein when a neutral setting is not present, the force action of the spring arrangement prevents the electrohydraulic solenoid valve from enabling the braking system, by acting counter to the electrical operation of the magnet of said solenoid valve.

In a preferred embodiment, the electro-hydraulic solenoid valve is designed 5 such that the supply of electrical current to its magnet causes a displacement of its control piston, so that the hydraulic signal which is triggered by the control piston when it is displaced enables the brake, as long as the spring device does not prevent displacement of the control piston.

It is particularly advantageous for the force/travel characteristic curves of the load spring and magnet to be matched in such a way that, when a neutral setting is not present, the force of the spring device or of the load spring does not allow the magnet to displace the control piston out of its initial position and thus enable the brakes, but with the magnet force however being sufficient, after the braking system has been enabled and if the neutral position is no longer permissibly present thereafter, to hold the control piston counter to the increased force of the spring system in its previously displaced position, and therefore to prevent the brakes from re20 engaging. This is achieved inter a/ia by means of a correspondingly steep characteristic curve of the magnet, the holding force of the magnet rising considerably with the displacement of the control piston, whereas the characteristic curve of the spring device or the load spring is very flat.

It is highly advantageous if the spring device, control piston and magnet can be combined to form a modular unit which, as a compact subassembly, can be integrated into a hydraulic pump or, if the high pressures are monitored, can also be mounted on the hydraulic motor. If the motor and brake also already form a modular unit, the result is therefore a system in which all the required pressures, such as high pressure in order to detect a neutral setting, and low pressure and tank pressure for actuating the brakes, are available internally in one modular unit, so that only one single additional control line, for operating the electrohydraulic solenoid valve from a switch which is arranged separately in the vehicle, is required.

It is likewise highly advantageous for the pressure for enabling or activating the braking system to be branched off from suitable lines of the hydraulic system. This increases the degree of integration of the system, and reduces the number of line connections between the modular units.

The feed pressure is preferably used to enable the braking system, and the tank pressure or housing pressure is preferably used to activate the braking system.

One advantageous embodiment involves utilizing, as a neutral setting signal, the displacement of a measuring piston counter to the spring device or the load spring as a function of a pressure which is impermissibly high for the neutral setting. The device for checking operating parameters which are relevant to a neutral position accordingly comprises a measuring piston which, as a function of the pressure in a line which is relevant to a neutral setting, can be displaced counter to the force of the spring arrangement, and as a result actuates the control piston of the electrohydraulic solenoid valve.

So that the measuring piston only actuates the control piston via the force of the spring arrangement, a mechanical stop is provided which correspondingly delimits the stroke of the measuring piston. The measuring piston can thus not actuate the spring piston through direct contact but only via the spring arrangement.

One advantageous design of the enabling circuit ensures that the space between the measuring piston and the control piston is connected to a pressure level, in particular the tank pressure, which is lower than the pressure to be monitored and is approximately constant.

So that the measuring piston is only displaced when a pressure which is impermissibly high for the neutral setting occurs, a return spring is preferably provided which is matched to the pressure and to that face of the measuring piston which is loaded by said pressure, and holds the measuring piston in the neutral position, and at a correspondingly low pressure, against a stop.

The diameter of the measuring piston is preferably matched to the force 35 level of the spring arrangement or load spring in such a way that the latter simultaneously forms the return spring.

Advantageous refinements of the invention involve the measuring piston being displaced as a function of the pressure state in the servo system of the pump of the hydraulic travel drive, or involve the measuring piston being displaced as a function of the high pressure in the propel drive.

The electrohydraulic solenoid valve is preferably operated with a higher 5 current in order to increase the holding force after the brake system has been enabled. For safety reasons, a device is also provided which cuts off the current supply to the electrohydraulic solenoid valve after a predefined period of time if the spring arrangement prevents the electrohydraulic solenoid valve from switching.

Further features and advantages of the invention can be gathered from the following description of the exemplary embodiments.

### BRIEF DESCRIPTION OF THE DRAWINGS

In the figures:

FIG. 1 shows a circuit diagram of the enabling circuit in interaction with the hydraulic system,

FIG. 2 shows an embodiment of the enabling circuit using a return spring and a load spring,

FIG. 3 shows an embodiment of the enabling circuit using only one spring.

### BRIEF DESCRIPTION OF THE PREFERRED EMBODIMENTS

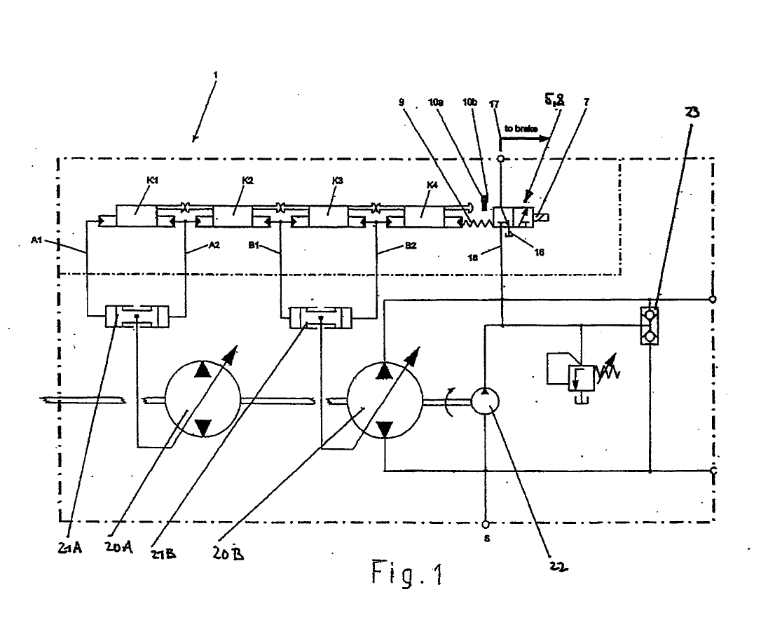

FIG. 1 illustrates the enabling circuit I and its integration into the hydraulic system. The latter has in each case one variable displacement pump 20A, 20B for supplying the hydraulic motors (not illustrated) for the two drive trains, said variable displacement pumps 20A, 20B each being assigned a servo system 21A, 21B for adjusting the supply flow. The braking system is enabled by pressurizing the pressure port 17 which leads to the brake, specifically only when it is ensured that the drive system is actually in a neutral setting. A suitable operating parameter for checking the neutral setting is the pressure in the servo lines Al, A2, BI, B2, which is used for this purpose in the exemplary embodiment shown.

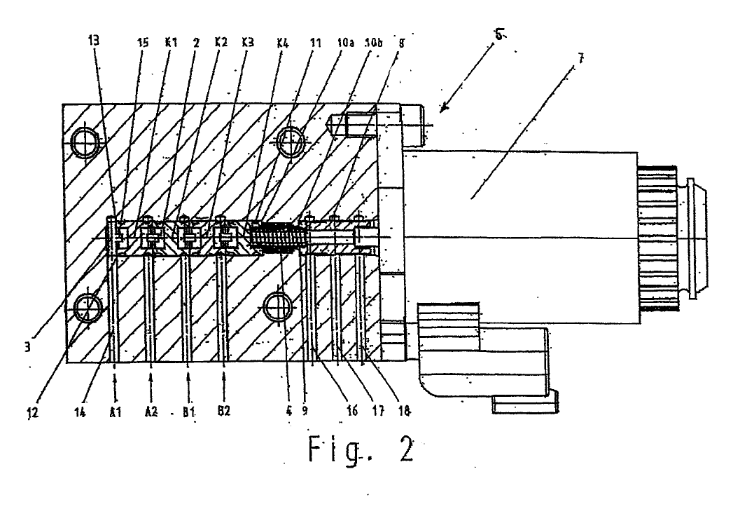

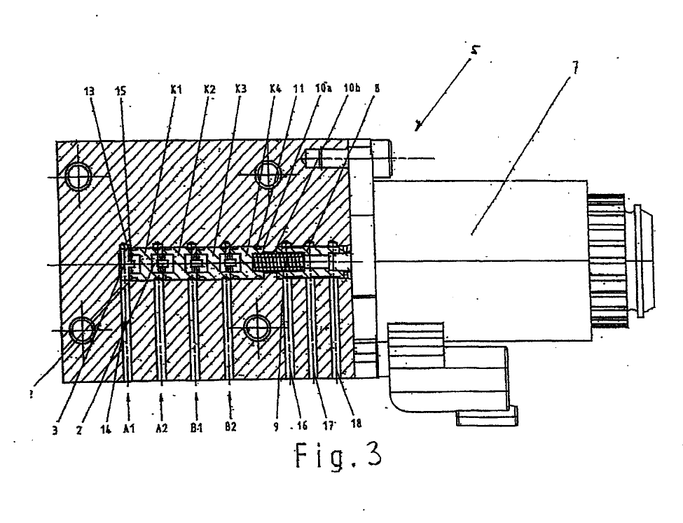

The enabling circuit I forms a separate subassembly which is integrated as such into the hydraulic system. Here, said enabling circuit I comprises the electrohydraulic solenoid valve 5 having the electromagnet 7 and its control piston 8, and the load spring 9 and the piston arrangement KI, K2, K3, K4 which, in the illustrated exemplary embodiment, form the device for checking operating parameters which are relevant to a neutral setting. Said arrangement simultaneously monitors the pressures at the four pressure ports Al, A2, BI, B2 of the servo lines. An impermissibly high pressure at one of the ports Al, A2, BI or B2 after stopping leads to the piston arrangement being displaced or split apart, with at least the outer piston K4, referred to as the measuring piston in the following, being displaced towards the load spring 9 and the control piston of the electromagnet being displaced in such a way that said control piston is prevented from enabling the braking system. Here, the stops IOa and lOb prevent direct contact between the measuring piston K4 and the control piston 8, so that the measuring piston K4 can only act on the control piston 8 of the magnet 7 via the load spring 9. Said mode of operation is described in more detail in the following on the basis of FIGS. 2 and 3.

The hydraulic pressure for enabling the braking system is provided from the feed pressure supply by the auxiliary pump 22, which is present in any case in relevant hydraulic systems, at the pressure port 18 of the electrohydraulic solenoid valve 5 upstream of the in-feed valve 23. For safety reasons, the brakes are connected such that they can only be enabled by being pressurized (via the port 17). If the brakes are, in contrast, applied, the port 17 is connected to the tank pressure port 16. This ensures that, in the event of any failure of the pressure supply, the brakes are automatically applied, and critical driving states are thus avoided.

FIG. 2 shows an exemplary embodiment of the enabling circuit according to the invention. As described previously, the circuit serves to monitor four servo lines in a dual path hydraulic drive. Other lines, for example the working lines, could however also be monitored in the same way.

Four pistons KI, K2, K3, K4 are arranged in the cylindrical bore 2, said pistons KI, K2, K3, K4 forming between them in each case, and between the first piston K1 and the base 3 of the bore, a space for introducing one of the pressures to be monitored, said pressures being applied via the pressure ports A, B and the supply ducts 14.

The pistons KI, K2, K3, K4 are pushed into contact with one another in the base 3 of the bore by means of a pressure spring, the return spring 4, the latter being supported on a stop which is formed in the bore 2, on a retaining pin or the like. For assembly reasons, the base 3 of the bore can also be formed as a detachable cover which closes off the cylindrical bore 2.

Impermissibly high pressure in one of the lines results in at least the measuring piston K4 being displaced counter to spring force, this result being independent of whether an increased pressure in the base of the bore displaces all the pistons together or the pressure in one of the other intermediate spaces splits the piston arrangement apart counter to the spring 4 at one side and towards the base 3 of the bore at the other side.

The pistons KI, K2, K3, K4 each have a transverse groove 15 the end side 13 in order to ensure optimum pressure action on the piston. In each case one annular groove II which generates narrow annular webs 12 between the piston end sides 13 and the annular grooves II is formed at the periphery of the piston, said annular webs 12 having smaller dimensions than the diameter of the supply ducts 14. The pistons are guided in a floating manner in the bore 2 in this way while an unbroken connection is simultaneously ensured between the supply ducts 14 and the piston end sides 13.

The stroke of the measuring piston K4 is limited by a stop IOa in the bore 2. A load spring 9 is supported at one side on the measuring piston K4 and at the other side on a control piston 8 of the electromagnet 7. The stroke of the control piston 8 is likewise limited by a stop lOb, so that the measuring piston K4 acts on the control piston 8 only via the load spring 9, and the measuring piston K4 and the control piston 8 never come into direct contact.

When the electromagnet 7 is switched on, the control piston 8 moves towards the pistons KI, K2, K3, K4 as long as the force generated by the electromagnet 7 on the control piston 8 prevails over the spring force of the load spring 9. Here, the spring forces of the load spring 9 are adapted such that only a relatively small force is exerted on the control piston when all the pistons KI, K2, K3, K4 are in their initial position. In this case, when the electromagnet 7 is switched on, the control piston 8 compresses the load spring 9 until it reaches its stop lOb in the bore 2. Here, the characteristic curve of the electromagnet 7 is dimensioned such that, in said state, the electromagnet 7 applies a sufficient holding force to hold the control piston 8 against the load spring 9 even when a corresponding high pressure is required during traveling and the pistons KI, K2, K3, K4 are retrospectively displaced counter to the load spring 9 (FIG. 2 shows this state). For this purpose, in said exemplary embodiment, the characteristic curve of the electromagnet 7 is additionally expanded by means of simultaneous variation of the switching current level.

If, on the other hand, when the magnet 7 is switched on, the load spring 9 10 has already been compressed by the displacement of the pistons KI, K2, K3, K4 as a result of a malfunction in the propel drive and, as a result, an increased spring force is exerted on the control piston 8, then the electromagnet 7 is not capable, as a result of the respective adapted characteristic curves, of displacing the control piston 8 out of its initial position counter to the more highly pre-loaded load spring 9.

In the exemplary embodiment, the control piston 8 has the function of a ⅔ directional valve. Its two switching positions determine the enablement or disablement of the braking system. When the electromagnet 7 is inactive, or the load spring 9 exerts too great a force counter to the active electromagnet 7, said control piston 8 is situated in its initial position. When the electromagnet 7 is active and the load spring exerts a sufficiently low force, said control piston 8, in its working position, is displaced towards the stop lOb in the bore 2.

The control piston 8 has three pressure ports: the tank pressure port 16, the pressure supply port 18, which preferably supplies feed pressure, and the pressure port 17 which leads to the braking system. In its initial position, the control piston 8 connects the pressure port 17, which leads to the braking system, to the tank pressure port 16, resulting in the brakes being relieved of pressure and preventing starting. In the working position of the control piston 8 against the stop lOb, the pressure port 17, which leads to the braking system, and the pressure supply port 18 are connected to one another, resulting in the brakes being released.

FIG. 3 shows an embodiment similar to that of FIG. 2.

The same reference symbols have been retained, and the mode of operation is, in substantial parts, the same as in FIG. 1, but with the difference that the load spring 9 simultaneously serves to return the pistons KI, K2, K3, K4.

In the setting illustrated in FIG. 3, the piston arrangement is displaced in the direction of the solenoid valve 5 or of the electromagnet 7 because, for example, an impermissibly high pressure prevails between the base 3 of the bore and the first piston KI, that is to say an impermissibly high pressure prevails at the pressure port Al. The load spring 9 acting on the control piston is, as a result, compressed to such an extent that the solenoid valve 5 cannot enable the brakes. In the neutral setting, the pistons KI, K2, K3, K4 are pushed into contact with one another in the base 3 of the bore 2 by means of the load spring 9, which then simultaneously serves as a return spring, it in turn being possible for said base 3 of the bore 2 to also be formed as a detachable cover which closes off the cylindrical bore 2.

In both embodiments, the enabling circuit operates as follows:

If a sufficiently high pressure to displace the piston out of its initial position counter to the force applied for returning the pistons is not present in any of the lines before the brakes are enabled, then the electromagnet can, when it is switched on, move the control piston counter to the small force of the load spring 9. The displacement of the control piston connects the pressure port 18 to the port 17 which leads to the braking system, and the brakes are released.

After the brakes are released, high pressure is required in any case when moving the vehicle. Increased pressure will therefore likewise occur in the servo lines, said high pressure, in the enabling circuit according to the invention, displacing the pistons counter to the force of the springs and of the magnet. The brakes cannot, however, re-engage, because the active magnet, as a result of its characteristic curve, can provide a sufficient holding force counter to a retrospective compression of the springs.

At rest, the piston arrangement is displaced back into the initial position in the base of the bore under spring force if the pressure in all the lines being monitored has dissipated to a sufficient extent. Abnormally high pressure in one of the lines, on the other hand, results in at least the outer piston, the measuring piston K4, being displaced or remaining displaced counter to the force of the load spring. If, on the other hand, when at rest before starting and before the magnet is switched on, at least the measuring piston K4 is already displaced because the pressure in at least one of the lines has not dissipated sufficiently, then the initial force of the magnet is not sufficient to displace the control piston counter to the force of the springs, and is not sufficient to enable the brakes such that they can be released.

1. Circuit for enabling or disabling a braking system of a hydraulic propel drive, having
a device for checking operating parameters which are relevant to a neutral setting,
a spring device, in particular a load spring (9), which acts counter to the control piston (8) of an electrohydraulic solenoid valve (5) which is designed to enable the braking system by means of electrical operation,
a device for generating a force, which is dependent on the neutral position, of the spring device,
wherein when a neutral setting is not present, the force action of the spring arrangement prevents the electrohydraulic solenoid valve (5) from enabling the braking system, by acting counter to the electrical operation of the electromagnet (7) of said solenoid valve (5).

2. Circuit according to claim 1, the electrohydraulic solenoid valve (5) being designed such that a supply of electrical current to its electromagnet (7) causes a displacement of its control piston (8), resulting in a hydraulic signal being triggered which enables the brake, as long as the spring device does not prevent displacement of the control piston (8).

3. Circuit according to claim 1, the force/travel characteristic curves of the load spring (9) and electromagnet (7) being matched such that, when a neutral setting is not present, the force of the load spring (9) does not allow the electromagnet (7) to displace the control piston (8) out of its initial position and thus enable the brakes, but the magnet force however being sufficient, after the braking system has been enabled and if the neutral position is no longer permissibly present thereafter, to hold the control piston (8) counter to the increased force of the spring system in its previously displaced position, and therefore to prevent the brakes from re-engaging.

4. Circuit according to claim 1, the spring device, control piston (8) and electromagnet (7) being combined to form a modular unit which, as a compact subassembly, can be integrated into or attached to a hydraulic device.

5. Circuit according claim 1, the electrohydraulic solenoid valve (5) controlling the feed pressure for enabling or activating the braking system in a line (17) which branches out from the hydraulic propel drive.

6. Circuit according to claim 5, the feed pressure being used to enable the braking system, and the tank pressure or housing pressure being used to activate the braking system.

7. Circuit according to claim 1, the device for checking operating parameters which are relevant to a neutral setting comprising a measuring piston (K4) which, as a function of the pressure in a line which is relevant to a neutral setting, can be displaced counter to the force of the spring arrangement, and as a result actuates the control piston (8) of the electrohydraulic solenoid valve (5).

8. Circuit according to claim 7, a mechanical stop (lOa) being provided which limits the stroke of the measuring piston (K4) such that the latter only actuates the control piston (8) via the spring arrangement.

9. Circuit according to claim 7, the space between the measuring piston (K4) and the control piston (8) being connected to a pressure level which is lower than the pressure to be monitored and is approximately constant, in particular to the tank pressure.

10. Circuit according to claim 7, a return spring (4) being provided which holds the measuring piston (K4) in the neutral position against a stop.

11. Circuit according to claim 10, the load spring (9) being matched to the force level of the measuring piston (K4) and of the setting piston (8) such that the load spring (9) simultaneously forms the return spring.

12. Circuit according to claim 7, the measuring piston (K4) being displaced as a function of the pressure in a servo system (21) of a pump of the hydraulic propel drive.

13. Circuit according to claim 7, the measuring piston (K4) being displaced as a function of the high pressure in the propel drive or the scavenging pressure.

14. Circuit according to claim 17, the electrohydraulic solenoid valve (5) being operated with a higher current in order to increase the holding force after the brake system has been enabled.

15. Circuit according to claim 1, a device being provided which cuts off the current supply to the electrohydraulic solenoid valve (5) after a predefined period of time if the spring arrangement prevents the electrohydraulic solenoid valve (5) from switching.
